(19) United States
(12) Patent Application Publication
(10) Pub. No.: US 2008/0216412 A1
(43) Pub. Date: Sep. 11, 2008

(54) WEATHERSEAL WITH IMPROVED SHOW SURFACE

(75) Inventor: Gennadiy Shumulinskiy, Oak Park, MI (US)

Correspondence Address: FAY SHARPE LLP, 1100 SUPERIOR AVENUE, SEVENTH FLOOR, CLEVELAND, OH, 44114, US

(73) Assignee: Cooper-Standard Automotive Inc.

(21) Appl. No.: 12/104,255

(22) Filed: Apr. 16, 2008

Related U.S. Application Data
(63) Continuation of application No. 10/832,913, filed on Apr. 27, 2004, now abandoned.

(51) Int. Cl. E06B 7/16

(52) U.S. Cl. 49/490.1; 49/506

(57) ABSTRACT

A weatherseal having an improved show surface is provided with an exterior cap that is either hinged to the body or separately formed and subsequently assembled thereto. The components of the weatherseal may be either extruded or molded, and the hinge provides the ability to form the assembly as one piece and then snap-fit the other end of the exterior cap into place over the body of the weatherseal.

### BACKGROUND OF THE INVENTION

This application relates to a weatherseal, and particularly to an outer belt seal provided along a lower edge of a window opening in a vehicle door. However, it will be appreciated that the invention is not limited to this particular application and may have use in similar environments requiring a high quality show surface of the weatherseal.

Belt line weatherstrips or weatherseals are generally well-known in the art. For example, commonly-owned U.S. Pat. Nos. 5,493,815, 5,618,593; 5,207,027; and 4,949,507, the details of which are incorporated herein by reference, disclose outer belt weatherseals. Some of these patents are directed toward improving the show surface, i.e, that outer or external portion of the weatherseal that faces outwardly from the vehicle, and in this instance along the lower periphery of the window opening in the door since these patents are directed to outer belts.

The prior art has developed over the years and can be generally summarized for background purposes by two belt weatherstrip assemblies generally illustrated in FIGS. 1 and 2 that are representative of these types of weatherseals. For example, FIG. 1 illustrates a supported elastomeric material (such as EPDM) having an inverted, generally U-shaped body with first and second legs supported by a rigid carrier, such as a metal carrier. The EPDM encapsulates the carrier and is conformed to grippingly engage a flange of the vehicle. For example, gripper fins extend inwardly from one or both of the legs to engage the metal flange of the vehicle and secure the weatherseal to the vehicle along the belt line and adjacent the window opening. A seal lip extends angularly outward from one of the legs of the body and typically includes a low-friction surface material that sealingly engages an outer surface of the window. The weatherseal may also include an additional lip to hide or partially cover a gap between the belt seal body and the seal lip, as well as a cushion lip at an outer terminal end of the second or outer leg that abuttingly engages the vehicle surface below the flange.

One of the legs of the body faces outwardly from the vehicle and provides the show surface. It is desirable that the show surface have a consistent, aesthetically pleasing surface finish since the show surface impacts on the overall aesthetics of the vehicle.

EPDM rubber was almost universally used as a sealing material because of its very good sealing characteristics, a long life, and other properties that make it particularly well suited to this application. Rubber seals provide a good seal, withstand a wide range of temperatures, and are easily extruded in configurations that allow them to be used in a wide variety of particular applications.

A persistent disadvantage of rubber seals is that they are normally coal black in color, and cannot be readily made in colors other than black. EPDM rubber is difficult or impossible to color, and therefore is almost universally black, and has a relatively low gloss. Although vehicle purchasers are used to low gloss seals for movable and fixed vehicle windows, there is a demand among vehicle designers for systems that allow different color choices, so that, for example, the seals can be matched or coordinated with body colors, chrome or other treatments can be used, and basically, that a wider variety of colors than dull black can be employed. Many attempts have been made to make the rubber seals more attractive by providing surface coatings of a plastic material or the like thereon, which can be both colored or textured to match the appearance of the vehicle on which the seals are used.

Another problem associated with extruded rubber seals relates to the need of using metal carriers in the gripper portion of the seal so that seal may be firmly attached to the flange of the door or car body. There are many disadvantages of using metal carrier in seats: additional manufacturing step of forming metal carrier; perplexity of cutting operation; necessity of end treatment due to rust of metal; weight of the seal etc., and all of these add cost to the sealing system.

In recent years, thermoplastic elastomers have become preferred materials rather than thermosetting materials, such as EPDM rubber, in many sealing applications. Good sealing characteristics of thermoplastic elastomers together with good colorability, feasibility of co-extruding with rigid polymers such as polyvinylchloride (PVC), polypropylene (PP), Nylon, etc., as well as with decorative films and ease of processing, give thermoplastic elastomers advantages over thermosetting materials, such as EPDM rubber, in many sealing applications.

Combination of rigid and flexible polymers allows manufacturers to create metal free weatherseals that considerably decrease the cost and improve design flexibility.

It is also known, as illustrated in FIG. 2, to provide a thermoplastic outer belt weatherseal. For example, the body is a molded or extruded thermoplastic assembly that typically does not include a rigid carrier, and a thin exterior show surface is provided in addition to the seal lip and hider lip constructions described and shown in FIG. 1. The arrangement of FIG. 2 illustrates that different portions of the assembly may be formed of different materials, for example, the body may be a more rigid thermoplastic while the seal lip is a more flexible material that conforms to the window surface.

Because of the different cooling and shrinkage rates of the different material components of the thermoplastic weatherseal, for example, the use of a rigid thermoplastic material as carrier and flexible materials as lips and grippers, the show surface often has an irregular surface finish. Proposed solutions include extruding a separate layer or adhesively securing a show surface, etc. to improve the aesthetic appeal. Unfortunately, these solutions either add undesired costs or complexity to the assembly, or result in an arrangement that is difficult to manufacture, assemble, or has quality control issues.

Thus, a need exists to resolve or improve upon show surface problems and imperfections associated with vehicle weatherseals such as outer belts.

### SUMMARY OF THE INVENTION

A weatherseal having an improved show surface includes a body having a generally inverted, U-shaped conformation. First and second legs of the body are dimensioned for mounting receipt over the vehicle flange. A seal lip extends from the first leg of the body and is adapted for sealing engagement with an associated vehicle window. An exterior cap is dimensioned to snap-fit over at least a portion of the second leg to provide an improved show surface.

In one embodiment, the exterior cap is unitarily hinged to the body.

A free end of the exterior cap has a hook conformation allowing the exterior cap to snap-fit over the similarly contoured body.

In one preferred embodiment, the exterior cap is hinged to an outer end of the second leg, while in another embodiment, the exterior cap is hinged to the first leg adjacent an interconnecting region of the body.

If desired, the exterior cap can be separately molded to improve the end treatment, and then separately snapped in place.

In another embodiment, the exterior cap follows a different contour than the second leg of the body.

In still another arrangement, gripper fins are eliminated and the second leg has a curved contour adapted to grip the associated vehicle flange.

A method of manufacturing a weatherseal having an improved show surface includes forming the body with first and second legs dimensioned for receipt over the associated vehicle flange. An exterior cap is formed and dimensioned for receipt over the second leg and includes a hook edge. The hook edge is extended into engagement with one of the first and second legs of the body.

A primary advantage of the invention is the improved aesthetics of the show surface.

Yet another benefit of the invention resides in the ease with which the weatherseal is manufactured.

Still another benefit is associated with the ease in assembling the arrangement.

Still other features and benefits of the invention will be described in the following detailed description.

### BRIEF DESCRIPTION OF THE DRAWINGS

FIG. 1 is a cross-sectional view of a prior art EPDM/metal outer belt weatherseal.

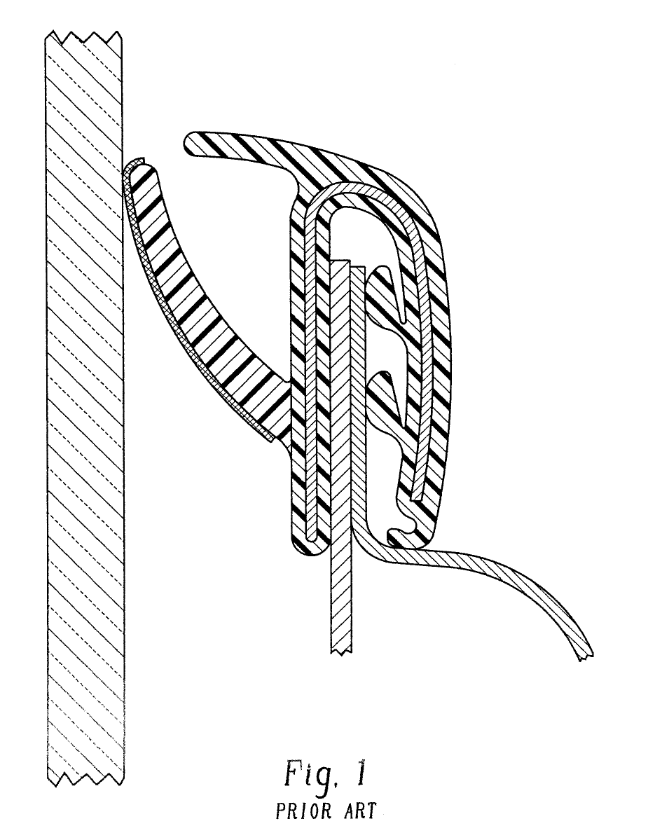

FIG. 2 is a cross-sectional view of a prior art thermoplastic outer belt weatherseal.

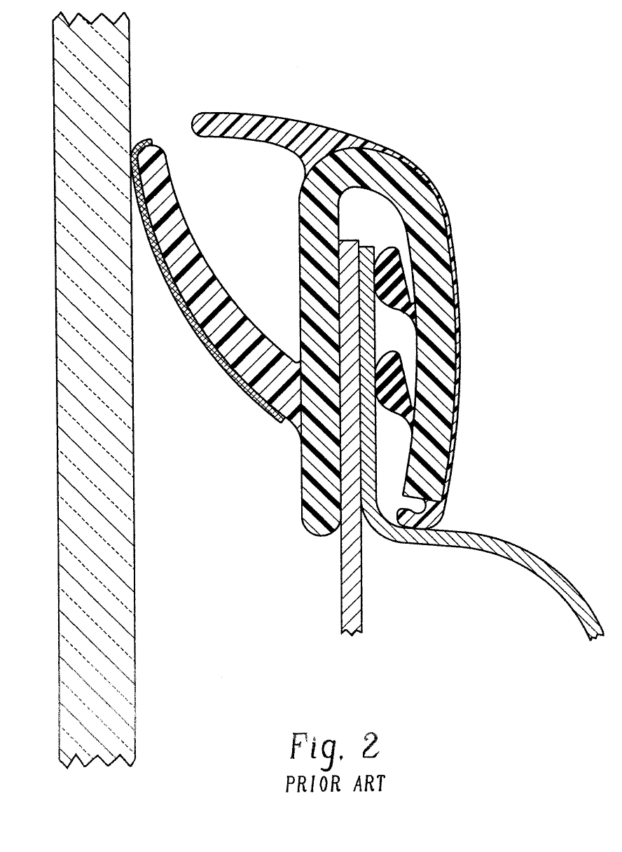

FIG. 3 is a cross-sectional view of a first preferred embodiment of the invention.

FIG. 4 is a cross-sectional view of the extrusion position of the weatherseal of FIG. 3.

FIG. 5 is a cross-sectional view of a second preferred embodiment of the invention.

FIG. 6 is a cross-sectional view of a third preferred embodiment of the invention.

FIG. 7 is a cross-sectional view of a fourth preferred embodiment of the invention.

FIG. 8 is a cross-sectional view of a fifth preferred embodiment of the invention.

FIG. 9 is a cross-sectional view of sixth preferred embodiment of the invention.

### DETAILED DESCRIPTION OF THE INVENTION

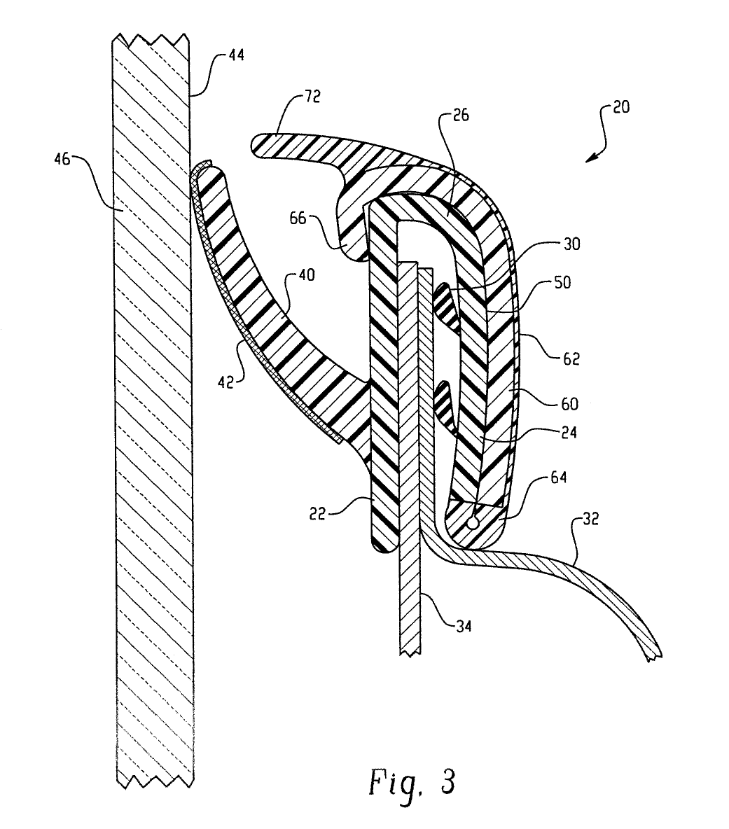

Turning to FIG. 3, a first embodiment of an outer belt weatherseal 20 is shown and includes an inverted, generally U-shaped body having a first leg 22 and a second leg 24 joined along an interconnecting region 26. Means for gripping such as individual gripper fins 30 extend inwardly from the second leg for gripping engagement with an outer vehicle flange surface 32, which is joined to inner vehicle flange 34. The flange portions are usually welded together in this region, and therefore the first and second legs of the weatherseal body extend in generally parallel relation with the vehicle flange in this region.

The weatherseal body is formed of a generally rigid plastic in this embodiment such as polypropylene. Extending outwardly from the first leg at an angle is a seal lip 40 that includes a coating or low-friction surface 42 on the surface of the seal lip that slidably engages surface 44 of the vehicle window 46. Preferably, the seal lip is formed of a less rigid material than the body so that the seal lip flexes and provides a wiping, sealing interface between the surface 42 and the window glass.

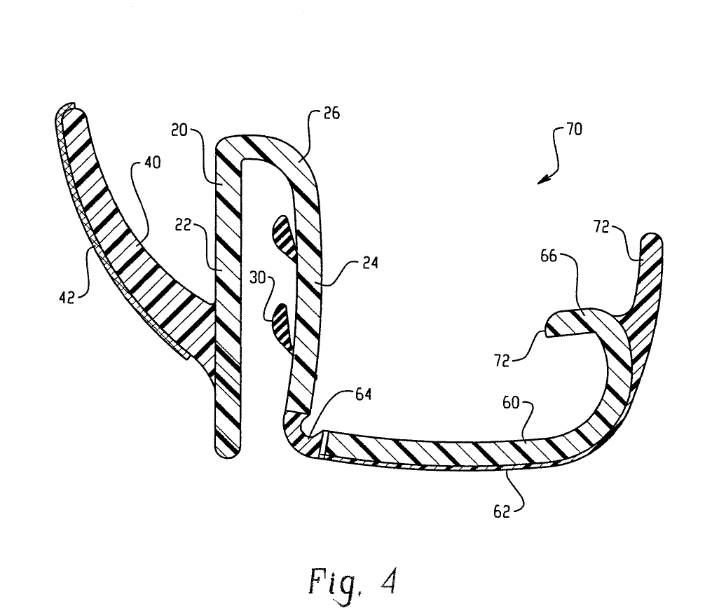

On an opposite surface of the second leg from the grippers is surface 50. In the prior art, this surface is often the show surface since it is visible from the exterior of the vehicle. In accordance with the present invention, however, surface 50 is covered by a mechanically engaged or snap-on exterior cap 60 having an improved, aesthetically pleasing outer surface or show surface 62 that can be made from different materials. The exterior cap is preferably unitarily attached to the body in the first preferred embodiment, and in particular is secured to the body along a hinge 64. The hinge 64 is formed from a less rigid, more flexible material such as a different thermoplastic or elastomeric material that allows the exterior cap to move relative to the body along the flexible hinge 64. This freedom of movement is particularly evident by comparing the extruded position shown in FIG. 4 with the installed position shown in FIG. 3. In this arrangement, the exterior cap is secured at a first end to the hinge 64 and includes a tightly curved engaging end or hook 66 at an opposite end that is dimensioned and adapted for a snap-fit engagement with the first leg 22 and interconnecting region 26 of the weatherseal body. Thus, the hook 66 has the same general contour as that of the first leg and interconnecting portion in this region and provides at least a partial mechanical engagement with the body. From the position shown in FIG. 4, the exterior cap rotates generally in the direction of reference numeral 70 (counter-clockwise as shown) and the hook 66 is lifted up and over the interconnecting region 26 of the body. The terminal end 72 of the hook engages the external surface of the first leg (FIG. 3). The hinge 64 is sufficiently flexible to allow the exterior cap to be rotated as shown by reference numeral 70 and also to lift upwardly (in the direction upwardly as shown in FIG. 4) to be received over the interconnecting portion 26 of the body. The flexibility of the hinge is such that the elastic nature of the material exerts a downward retaining force so that the hook end is not easily removed from the installed position shown in FIG. 3 once the cap is snapped over the body.

In addition, a hider lip 72 extends from the exterior cap. The lip 72 extends outwardly from the exterior cap adjacent the hook 66 and covers a gap between the body and the seal lip when the weatherseal is mounted along the belt line of the window opening. The lip covers a perceived gap between the body and the seal lip that would otherwise be apparent when the weatherseal is installed on the vehicle.

As shown, the exterior cap may be formed of the same material as the U-shaped body. On the other hand, the hider lip 72 is preferably formed of a different material, such as the same flexible elastomeric material used to form the hinge 64. Thus, in the arrangement of FIGS. 3 and 4, a thermoplastic co-extrusion method is used in which up to three or four different dissimilar materials are used to form the assembly. It will be appreciated, though, that the assembly could be molded.

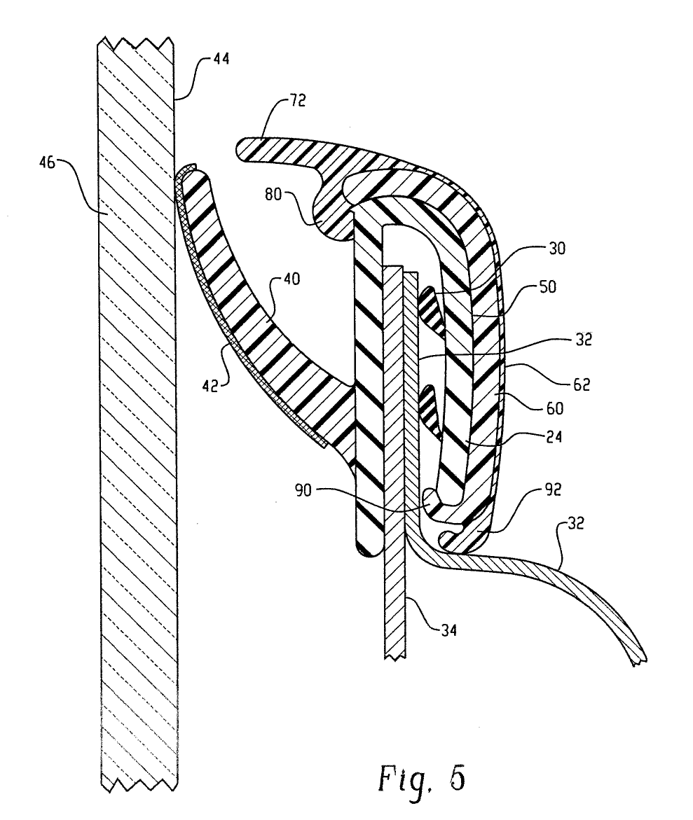

A second preferred embodiment is shown in FIG. 5. For ease of reference, like components are referred to by like reference numerals with a primed suffix (′) and new components with a new numeral. The primary area of distinction is the location of hinge 80. Particularly, the exterior cap 60′ is formed with the hinge 80 at one end opposite from the hook 90. Here, however, the hook 90 is located at the terminal end of the second leg and adapted to conform around the terminal end of the leg while providing a connection with the hinge adjacent the hider lip 72′. In other words, the location of the hook and the hinge are reversed in the embodiment of FIG. 5 relative to that shown in FIGS. 3 and 4.

In addition, a cushion lip 92 proceeds outwardly from the exterior cap adjacent the hook 90 for engagement with the outer vehicle flange 32. As will be appreciated, although shown in an installed position in FIG. 5, the show surface 62′ of the exterior cap faces outwardly of the vehicle and covers the outer face 50 of the second leg.

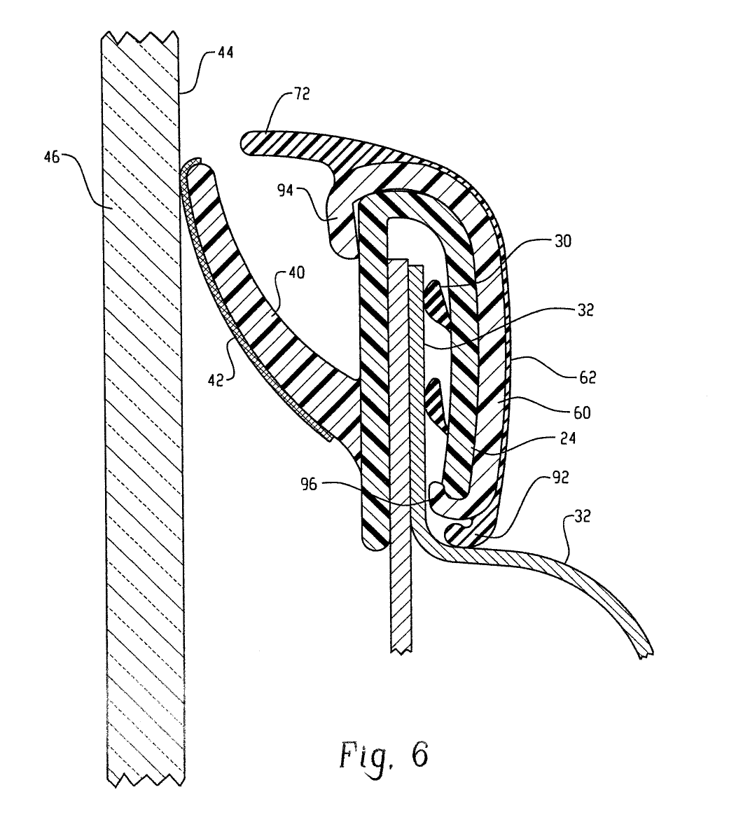

In FIG. 6, a separate snap-on exterior cap is shown. It includes hook conformations 94, 96 at opposite ends thereof that cooperate with the first leg interconnecting region 22′, 26′ at one end and with the outer terminal end of the second leg 24′ on the other end. The exterior cap is separately formed and is assembled to the body of the weatherseal by first inserting one of the hook regions, such as hook 96, about the lower terminal end of the second leg. The exterior cap is then rotated in a counter-clockwise direction as shown until the hook 94 snap-fits over the interconnecting region and upper end of the first leg. Alternatively, the exterior cap could be assembled by first installing the hook 94 in place over the upper end of the first leg and rotating the remainder of the cap into snap-fit engagement of hook 96 over the lower end of the second leg.

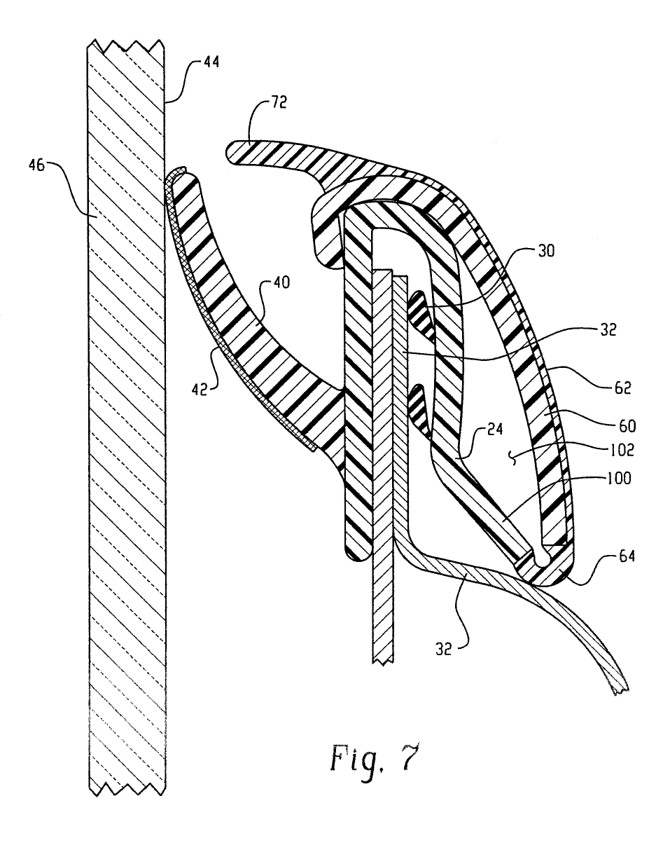

FIG. 7 is perhaps most closely related to the embodiment of FIGS. 3 and 4 described above. That is, the outer belt weatherseal includes a hinge 64′ secured to the outer terminal end of the second leg. Here, the outer end of the second leg includes an angled portion 100 that extends in diverging relation from the otherwise generally parallel relation between the first and second legs of the body. Thus, in the region of the grippers 30′, the first and second legs extend in generally parallel relation which, in turn, conforms to and is parallel to the vehicle flange in this region. The angled portion 100 in the second leg, proceeds away from the flange and positions the hinge 64′, like the embodiment of FIG. 3, to serve as a cushion lip engaging the outer metal flange 32′. The exterior cap is connected at a first or lower end to the hinge and terminates in a hook 66′ at the second end adjacent the hiding lip 72. The contour of the exterior cap, however, is different from and spaced from the second leg to define a cavity 102. Thus, the show surface may not follow the same contour as the second leg as it proceeds over the flange. It will also be appreciated from a review of FIG. 7 that although the hinge 64′ is located at the lower end of the second leg, the reverse arrangement where the hinge is located at the top as seen in the embodiment of FIG. 5 could be used without departing from the scope and intent of the invention.

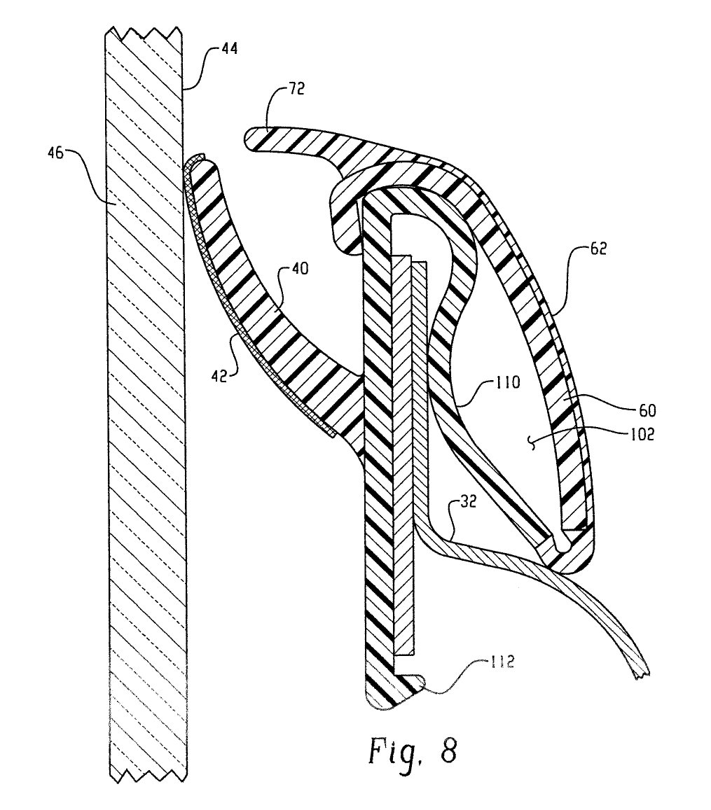

In FIG. 8, the grippers 30 used in the prior embodiments are eliminated. Instead, the second leg has a curved contour, specifically, a concave portion adapted to grippingly engage against the flange of the vehicle. Thus, the second leg is non-parallel to the first leg and the concave portion 110 serves the gripping function of the prior embodiments. The outer, terminal end of the second leg also angles outwardly and is more akin to the arrangement of FIG. 7, where the hinge 64′ engages the body panel of the vehicle as a cushion lip and the remainder of the exterior cap follows a smooth arcuate, non-parallel contour relative to the first leg. The hook 66′ at the end of the exterior cap adjacent hiding lip 72′ performs a snap-on feature to secure the show surface in place. An additional overhang or hook 112 is provided at the lower end of the first leg for receipt in an opening of the inner flange of the vehicle.

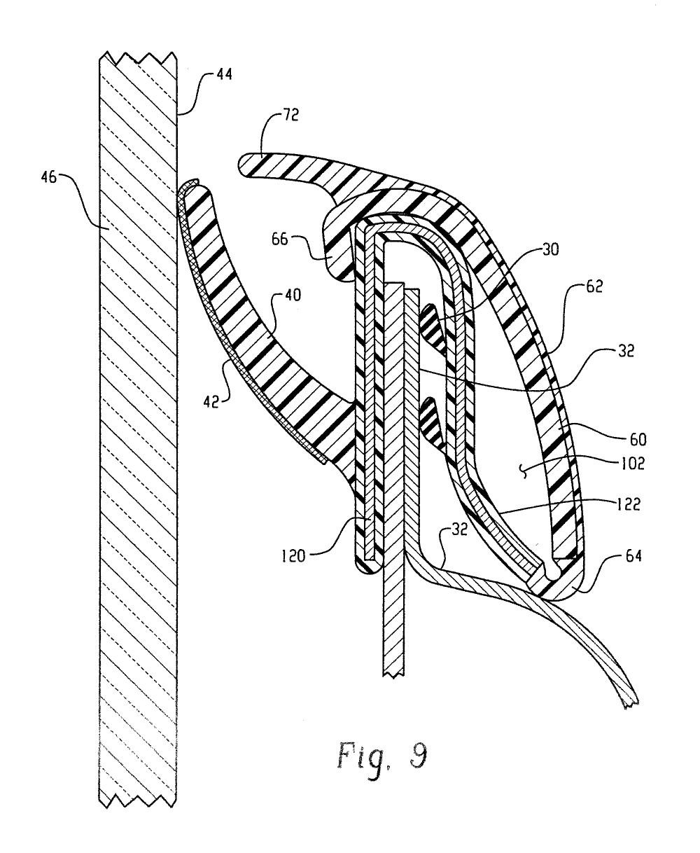

The embodiment of FIG. 9 illustrates that the weatherseal body may be reinforced with a rigid carrier, such as metal carrier 120. The carrier is preferably encapsulated in the material of the body, i.e., along the first and second legs 22′, 24′, as well as the interconnecting portion 26′. The second leg also includes a series of grippers 30′ to engage the weld flange along a region of the second leg that extends generally parallel to the first leg. The outer end of the second leg has a curvilinear contour 122 that merges into the hinge portion 64′. Again, the exterior cap is secured to the hinge at a first end and includes hook 66′ at the opposite end for receipt over the interconnecting portion of the first leg. Here, the first and second legs are preferably an elastomeric material such as EPDM extruded over the metal carrier. Thus, the seal lip and body are all an EPDM material (with the body reinforced with a metal carrier) and the exterior cap formed of a co-extruded thermoplastic. The hinge 64′ is also co-extruded and has the same flexibility as the seal lip, while hiding lip 72′ may be formed of a dissimilar material if so desired.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A weatherseal received on an associated vehicle having an improved show surface, the weatherseal comprising:
a body having a generally inverted U-shaped conformation including first and second legs dimensioned for mounting receipt over an associated vehicle flange;
a seal lip extending from the first leg of the body for sealing engagement with an associated vehicle window; and
an exterior cap dimensioned to snap-fit over at least a portion of the second leg to provide an improved show surface.

2. The invention of claim 1 wherein the exterior cap is connected along a hinged region with the second leg.

3. The invention of claim 2 wherein the exterior cap snap fits over a region of the body spaced from the hinged region.

4. The invention of claim 2 wherein the exterior cap is integrally molded to the body.

5. The invention of claim 1 wherein the exterior cap is a separate component from the body.

6. The invention of claim 5 wherein the exterior cap snaps over the second leg.

7. The invention of claim 6 wherein the exterior cap snaps over the first leg.

8. The invention of claim 5 wherein the exterior cap snaps over the first leg.

9. The invention of claim 1 wherein one of the first and second legs includes means for gripping the associated flange.

10. The invention of claim 1 wherein the body includes a rigid reinforcing member therein.

11. The invention of claim 1 wherein the exterior cap includes a finish layer on an outer surface thereof.

12. The invention of claim 1 wherein the sealing lip includes a low friction layer thereon.

13. The invention of claim 1 further comprising an additional lip for hiding the seal lip from view.

14. The invention of claim 1 wherein the seal lip is formed of a different material than the body.

15. The invention of claim 1 wherein the first and second legs of the body are substantially parallel.

16. The invention of claim 15 wherein the exterior cap has a different contour than the second leg.

17. The invention of claim 15 wherein the exterior cap has substantially the same contour as the second leg.

18. The invention of claim 1 wherein the exterior cap is hinged to the first leg.

19. The invention of claim 1 wherein the exterior cap is hinged to the second leg.

20. A method of manufacturing a weatherseal having an improved show surface comprising the steps of:
forming a body having first and second legs dimensioned for receipt over an associated vehicle flange, the first leg including a seal lip adapted to engage an associated vehicle window;
forming an exterior cap dimensioned for receipt over the second leg and including a hook edge; and
extending the hook edge into engagement with one of the first and second legs of the body.

21. The invention of claim 20 comprising the cap forming step includes the step of forming a hinge between the exterior cap and the body.

22. The invention of claim 21 wherein the hinge forming step interconnects the exterior cap and the first leg.

23. The invention of claim 22 comprising the step of folding the exterior cap along the hinge and the hook edge of the exterior cap engages the second leg.

24. The invention of claim 21 wherein the hinge forming step interconnects the exterior cap and the second leg.

25. The invention of claim 24 comprising the step of folding the exterior cap along the hinge and the hook edge of the exterior cap engages the first leg.

26. The invention of claim 20 wherein the body and exterior cap forming steps include the step of extruding at least one of the body and exterior cap.

27. The invention of claim 26 wherein the body and exterior cap forming steps include the step of extruding both of the body and exterior cap.

28. The invention of claim 26 wherein the body and exterior cap forming steps include extruding a hinge from a different material than the body and exterior cap.

29. The invention of claim 20 wherein the body and exterior cap forming steps include the step of molding at least one of the body and exterior cap.

30. The invention of claim 20 wherein the body and exterior cap forming steps include the step of molding both of the body and exterior cap.
